(19) United States
(12) Patent Application Publication
(10) Pub. No.: US 2005/0275201 A1
(43) Pub. Date: Dec. 15, 2005

(54) Occupant restraint arrangement on the driver's side of a vehicle

(75) Inventors: Michael Schneider, Sulzbach (DE); Christian Gehlert, Hosbach (DE)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 11/147,894

(22) Filed: Jun. 8, 2005

(30) Foreign Application Priority Data
Jun. 15, 2004 (DE) 20 2004 009 451.7

(51) Int. Cl. B60R 21/16

(52) U.S. Cl. 280/731

(57) ABSTRACT

An occupant restraint arrangement on the driver's side of a vehicle includes an inflatable gas bag (10). On activation the gas bag (10) emerges from a steering wheel of the vehicle. The gas bag (10) is uncoupled from the steering wheel in a direction of the steering wheel rotation about a steering wheel axis (A). In an inflated state the gas bag (10) has an asymmetrical shape with respect to the steering wheel axis (A). The gas bag (10) in the inflated state has a protrusion (12) which covers at least a portion of an A-column (14) of the vehicle on the driver's side.

### TECHNICAL FIELD

The invention relates to an occupant restraint arrangement on the driver's side of a vehicle.

### BACKGROUND OF THE INVENTION

An occupant restraint arrangement comprising an inflatable gas bag which is uncoupled from the steering wheel of the vehicle in the direction of the steering wheel rotation is known from the DE 297 02 441 U. In the inflated state the gas bag has an asymmetrical shape with respect to the steering wheel axis.

In general, gas bags which are uncoupled from the steering wheel basically offer a greater design freedom as regards size and shape than standard gas bags which are entrained by the steering wheel rotation. Standard driver gas bags are generally shaped so as to be rotationally symmetrical, so that they have the same unfolding behaviour in every steering wheel position. However, it is to be noted that the filling capacity of gas generators on the driver's side is limited.

To protect the driver from contact with the A-column of the vehicle, separate side gas bags are used which unfold downwards from the roof area of the vehicle (so-called “curtain bags”), or special gas bags which unfold out from the A-column. Curtain bags, however, are not necessarily part of the standard equipment of a vehicle. Moreover, in particular types of vehicles, in particular in convertibles, curtain bags can not be installed at all. However, especially for convertibles a corresponding protection for the driver would be desirable, owing to the very oblique A-column and windscreen. Gas bags which are integrated into the A-column do not represent a sufficiently satisfactory solution, due to the difficulty in accommodating a gas bag in the structural space of the A-column and due to the high costs.

It is therefore an object of the invention to provide for the driver a protective measure against an impact onto the A-column, which is able to be realized at a favourable cost and irrespective of the type of vehicle.

### BRIEF SUMMARY OF THE INVENTION

This is achieved by an occupant restraint arrangement on the driver's side of a vehicle, comprising a gas bag, which on activation emerges from a steering wheel of the vehicle. The gas bag is uncoupled from the steering wheel in a direction of steering wheel rotation about a steering wheel axis. The gas bag in an inflated state has an asymmetrical shape with respect to the steering wheel axis. The gas bag in the inflated state has a protrusion which covers at least a portion of an A-column of the vehicle on the driver's side. According to the invention, the driver is protected from an impact onto the A-column by a gas bag emerging from the steering wheel of the vehicle, which in the meantime is provided as a standard restraint arrangement in every type of vehicle. The uncoupling of the gas bag from the steering wheel permits a non rotationally symmetrical shape of the gas bag with respect to the steering wheel axis. According to the invention, the gas bag has a special protrusion which in the inflated state, i.a., offers a dedicated protection from an impact onto the A-column. The protrusion can assume various shapes and is to be adapted to the respective vehicle. Otherwise, the gas bag of the occupant restraint arrangement according to the invention can be constructed as a standard gas bag, so that a reliable restraint behaviour for the standard impact conditions is achieved.

For a dedicated covering of the A-column it is recommendable that the protrusion extends with respect to the steering wheel axis substantially within an angle range of 270° to 360° (in left-hand vehicles, i.e. vehicles in which the steering wheel is arranged on the left side of the vehicle) or within an angle range of 0° to 90° (in right-hand vehicles).

The restraint arrangement according to the invention can also be provided advantageously in a variant in which the gas bag is coupled to the steering wheel of the vehicle in the direction of the steering wheel rotation about a steering wheel axis.

Advantageous and expedient developments of the occupant restraint arrangement according to the invention, in particular with respect to the gas bag, are indicated in the sub-claims.

### BRIEF DESCRIPTION OF THE DRAWINGS

FIG. 1 shows a top view of an inflated gas bag of an occupant restraint arrangement according to the invention; and

FIG. 2 shows a perspective view of a vehicle interior with an inflated gas bag of an occupant restraint arrangement according to the invention.

### DETAILED DESCRIPTION OF THE PREFERRED EMBODIMENT

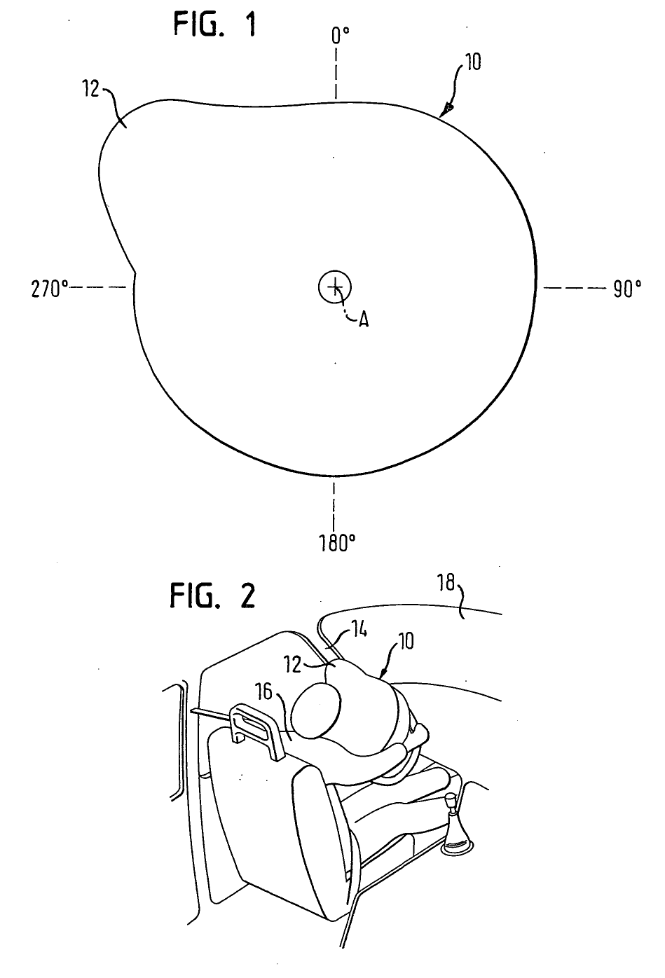

In FIG. 1 a gas bag 10 of an occupant restraint arrangement according to the invention is illustrated in the inflated state, from the viewpoint of the driver. The gas bag 10 is uncoupled from the steering wheel of the vehicle in the direction of the steering wheel rotation. Thus, the gas bag 10 unfolds on an activation of the occupant restraint arrangement into the shape illustrated in FIG. 1 independently of the current steering wheel position. This presupposes a steering wheel in which the gas bag module of the occupant restraint arrangement is housed in a fixed central part of the steering wheel, or a comparable construction.

The shape of the gas bag 10 corresponds largely to that of a proven standard gas bag on the driver's side used in steering wheels without a fixed central part. The gas bag 10 of the occupant restraint arrangement according to the invention is substantially rotationally symmetrical with respect to the steering wheel axis A. However, the gas bag 10 has a highly distinct protrusion 12, so that in the end an asymmetrical gas bag shape is produced with respect to the steering wheel axis A. As can be seen in FIG. 1, the protrusion 12 extends with respect to the steering wheel axis A substantially in an angle range of 270° to 360°, when from the viewpoint of the driver the “12 o'clock” direction of the steering wheel is established as the 020 line.

FIG. 2 shows that the protrusion 12 of the gas bag 10 is dedicated to cover a portion of the A-column 14 of the vehicle on the driver's side. Thus, in particular in the case of an oblique impact, a contact of the driver 16 with the A-column 14 is avoided. The protrusion 12, which upon unfolding of the gas bag 10 places itself around the A-column 14, is shaped so that at the contact point to the A-column 14 a sufficient gas bag depth is available in order to efficiently parry an impact onto the A-column 14.

In vehicles in which the steering wheel is arranged on the right side of the vehicle (right-hand vehicles), the protrusion 12 extends in relation to the steering wheel axis A in an angle range of 0° to 90°.

In addition to the protrusion 12 for the covering of the A-column 14, the gas bag 10 can have a further protrusion which covers a portion of the windscreen 18 of the vehicle. This further protrusion extends with respect to the steering wheel axis A preferably substantially within an angle range of 0° to 90° (left-hand vehicle) or from 270° to 360° (right-hand vehicle).

Furthermore, the gas bag 10 can have an expansion to protect the abdominal area of the driver 16. The expansion extends with respect to the steering wheel axis A substantially within an angle range of 150° to 210°.

The gas bag 10 is produced from two blanks lying one over the other, which are sewn together on the edge or connected with each other in another manner.

1. An occupant restraint arrangement on the driver's side of a vehicle, said occupant restraint arrangement comprising an inflatable gas bag, which on activation emerges from a steering wheel of said vehicle, said gas bag being uncoupled from said steering wheel in a direction of steering wheel rotation about a steering wheel axis, said gas bag in an inflated state having an asymmetrical shape with respect to said steering wheel axis, said gas bag in the inflated state having a protrusion which covers at least a portion of an A-column of said vehicle on said driver's side.

2. The occupant restraint arrangement on the driver's side according to claim 1, wherein said protrusion lies against said A-column.

3. The occupant restraint arrangement on the driver's side according to claim 1, wherein said protrusion extends with respect to said steering wheel axis substantially within an angle range of 270° to 360°.

4. The occupant restraint arrangement on the driver's side according to claim 1, wherein said protrusion extends with respect to said steering wheel axis substantially within an angle range of 0° to 90°.

5. The occupant restraint arrangement on the driver's side according to claim 1, wherein said gas bag in said inflated state has a substantially rotationally symmetrical shape with respect to said steering wheel axis, apart from the protrusion.

6. The occupant restraint arrangement on the driver's side according to claim 1, wherein said gas bag in said inflated state has a further protrusion which covers a portion of a windscreen of said vehicle.

7. The occupant restraint arrangement on the driver's side according to claim 6, wherein said further protrusion with respect to said steering wheel axis (A) extends substantially within an angle range of 0° to 90°.

8. The occupant restraint arrangement on the driver's side according to claim 6, wherein said further protrusion with respect to said steering wheel axis (A) extends substantially within an angle range of 270° to 260°.

9. The occupant restraint arrangement on the driver's side according to claim 1, wherein said gas bag in said inflated state has an expansion to protect an abdominal area of a driver.

10. The occupant restraint arrangement on the driver's side according to claim 9, wherein said expansion extends with respect to said steering wheel axis substantially within an angle range of 150° to 210°.

11. The occupant restraint arrangement on the driver's side according to claim 1, wherein said gas bag is formed from two blanks lying one over the other.

12. An occupant restraint arrangement on the driver's side of a vehicle, said occupant restraint arrangement comprising an inflatable gas bag, which on activation emerges from a steering wheel of said vehicle, said gas bag being coupled to said steering wheel in a direction of steering wheel rotation about a steering wheel axis, said gas bag in an inflated state having an asymmetrical shape with respect to said steering wheel axis, said gas bag in the inflated state having a protrusion which covers at least a portion of an A-column of said vehicle on said driver's side.
